(19) United States
(12) Patent Application Publication
(10) Pub. No.: US 2006/0239195 A1
(43) Pub. Date: Oct. 26, 2006

(54) Method and apparatus for dual-mode application update protocol

(76) Inventors: Martin Camins, Waterloo (CA); Jeffrey Wyman, Kitchener (CA); Michael Reuter, Carol Stream, IL (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/114,051

(22) Filed: Apr. 26, 2005

(51) Int. Cl. H04J 1/16

(52) U.S. Cl. 370/235

(57) ABSTRACT

A method of distributing a set of data, such as a software application update, to a plurality of nodes in a network. Also, devices, systems and networks for implementing the method. The nodes can be any computerized devices, but computerized medical devices used in nurse call systems are particularly relevant. According to the method, either a unicast mode or a multicast mode may be used to distribute the set of data over the network. Once the set of data has been distributed, the nodes provide feedback to a network server concerning whether the set of data was accurately received.

### FIELD OF THE INVENTION

The present invention relates generally to methods of distributing data to nodes in a network. In addition, the present invention relates generally to networks, devices and/or systems for implementing such methods.

### BACKGROUND OF THE INVENTION

Many of today's commonly-used software applications are updated on a regular basis, often yearly. Therefore, computer network administrators are frequently required to install software application updates (e.g., software patches) on each of the computers in their networks. In some cases, the updates are installed one computer at a time. Typically, such computer-by-computer installation is performed by individually establishing File Transfer Protocol (FTP) sessions between a network server and each of the computers on the network.

As will be appreciated by those of skill in the art, individually updating each computer's software can be extremely time consuming and inefficient. Therefore, another approach to installing software updates on a plurality of computers in a network involves using a streaming or multicasting protocol. According to this approach, the server streams the data in a software application update to multiple network computers as packets in an Ethernet multicast.

While this is less time consuming than using FTP sessions to unicast to each network computer individually, multicasting is disadvantageous for several reasons. For example, intended data recipients of a multicast do not notify the server of whether they have received the data packets accurately. In fact, the server does not have a way to determine if any of the multicast data reaches the intended recipients at all.

In view of this shortcoming, network administrators who multicast software application updates often attempt to maximize the number of network computers that obtain a complete and accurate set of data by multicasting the same set of data numerous times. Unfortunately, multiple multicasting uses up a relatively large amount of network bandwidth and can bog down the entire network. This is particularly true when the software application update is large. To make things worse, even after repeated multicastings, the network administrator still receives no confirmation from the network computers that each computer has received the multicast data accurately and completely.

The above-mentioned shortcomings of general computer networks can be particularly frustrating to administrators who are attempting to establish and/or maintain networks between pieces of computerized nurse call equipment. In order to understand the source of this frustration, one must first appreciate that computerized nurse call equipment typically relies on proprietary protocols. Thus, substantial effort would be needed to adapt such equipment to the Ethernet protocol commonly used by computer networks.

However, at least for the reasons discussed above, currently-available general computer networks are not particularly well suited for distributing software application updates to computers. Therefore, computerized nurse call equipment manufacturers may be understandably reluctant to replace one imperfect system for another. Ultimately, this prevents network administrators from benefiting from the positive aspects of the protocol (i.e., multicasting) and restricts them to having to update software applications one piece of computerized nurse call equipment at a time.

At least in view of the above, there is a need for new devices, systems and methods that allow for nodes on a network (e.g., computerized nurse call equipment) to receive sets of data (e.g., updated software applications) in a more efficient and/or reliable manner. In other words, devices, methods and/or systems for distributing a set of data more reliably, more quickly and/or with less bandwidth usage would be desirable. Also desirable would be networks of computerized nurse call equipment, such as nurse call systems, that can make use of the Ethernet protocol to distribute software application updates.

### SUMMARY OF THE INVENTION

According to certain embodiments of the present invention, a method of distributing a set of data to a plurality of nodes in a network is provided. This method includes establishing how many nodes in a network should receive a set of data and establishing how large the set of data is. This method also includes unicasting the set of data to nodes that should receive the set of data upon determining that fewer than a predetermined number of nodes should receive the set of data and that the set is smaller than a predetermined size. This method further includes multicasting the set of data to the nodes that should receive the set of data upon determining either that more than the predetermined number of nodes should receive the set of data or that the set of data is larger than the predetermined size.

According to certain other embodiments of the present invention, a first type network is provided. This network includes establishing means for establishing how many nodes in a network should receive a set of data. The establishing means is also for establishing the size of the set of data (i.e., how large the set of data is). The network also includes unicasting means for unicasting the set of data to nodes that should receive the set of data upon determining that fewer than a predetermined number of nodes should receive the set of data and that the set of data is smaller than a predetermined size. The network further includes multicasting means for multicasting the set of data to the nodes that should receive the set of data upon determining either that more than the predetermined number of nodes should receive the set of data or that the set of data is larger than the predetermined size.

According to yet other embodiments of the present invention, a second type of network is provided. This network includes a plurality of network nodes and a network server that is operably connected to the plurality of network nodes. In this network, the network server includes a first processor configured to establish how many of the plurality of network nodes should receive a set of data. The first processor is also configured to establish how large the set of data is. The network server also includes a first transceiver configured to unicast the set of data to nodes that should receive the set of data upon determining that fewer than a predetermined number of nodes should receive the set of data and that the set of data is smaller than a predetermined size. In addition, the network server includes a second transceiver configured to multicast the set of data to the nodes that should receive the set of data upon determining either that more than the predetermined number of nodes should receive the set of data or that the set of data is larger than the predetermined size.

In accordance with yet other embodiments of the present invention, a method of distributing a software application update to a plurality of devices in a network is provided. This method includes establishing how much data is to be transmitted over a network in order to perform a software application update on a set of devices within the network. The method also includes unicasting data to devices that should receive the software application update upon determining that fewer than a predetermined amount of data is needed to perform the software application update. In addition, this method also includes multicasting the data to the devices that should receive the software application update upon determining that more than the predetermined amount of data is needed to perform the software application update.

There has thus been outlined, rather broadly, certain embodiments of the invention in order that the detailed description thereof herein maybe better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates a flowchart that includes the steps of a method of distributing a set of data to a plurality of nodes in a network according to the claimed invention according to one embodiment of the claimed invention;

FIG. 2 illustrates a flowchart that includes the steps of a method of distributing a software application update to a plurality of devices in a network according to another embodiment of the claimed invention;

FIG. 3 illustrates a flowchart that includes the steps of a method of distributing a set of data to a plurality of nodes in a network according to yet another embodiment of the claimed invention; and

FIG. 4 illustrates a block diagram of a representative network according to still another embodiment of the claimed invention.

### DETAILED DESCRIPTION

At least in view of the above-mentioned shortcomings of the prior art, new devices, systems and methods have been developed to distribute a set of data over a network. Embodiments of the claimed invention will now be described with reference to the drawing figures, in which like reference numerals refer to like parts throughout.

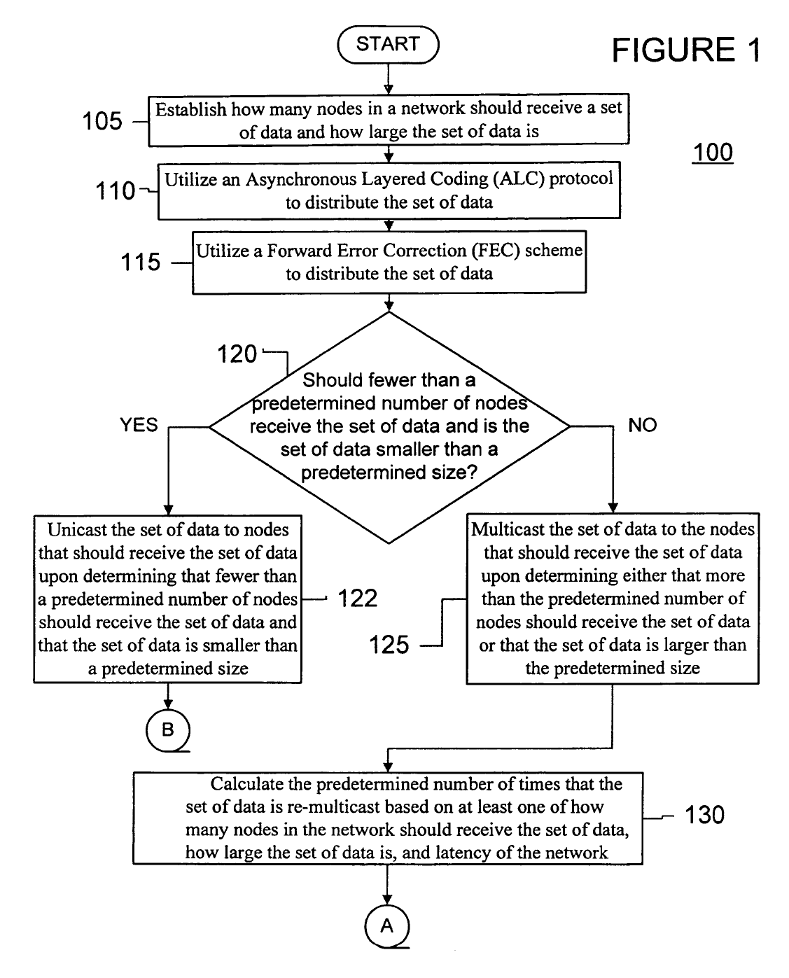

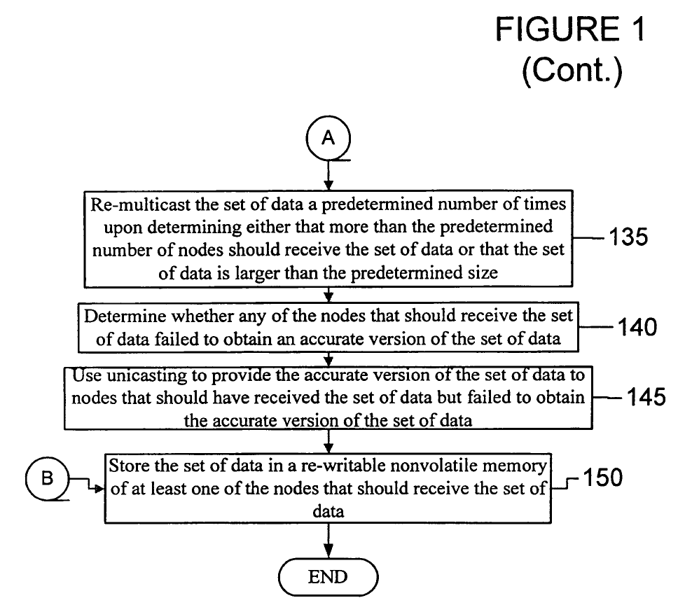

FIG. 1 illustrates flowchart 100, which includes steps of a method of distributing a set of data to a plurality of nodes in a network according to an embodiment of the claimed invention. Although no particular limitations are placed on the kind of data that may be included in the set of data, data pertaining to software application updates is particularly relevant to certain embodiments of the claimed invention.

No particular restrictions are made on the kind of nodes that may be included in the network either. However, networked computers are of particular interest to certain embodiments of the present invention. Also, networked pieces of computerized nurse call equipment are of particular interest to other embodiments of the claimed invention.

Step 105 at the top of FIG. 1 specifies establishing how many nodes in a network should receive a set of data. Step 105 also specifies establishing the size of the set of data (i.e., how large the set of data is). These steps are typically performed within a network server, although they may be performed elsewhere.

Once the size of the set of data and the number of nodes to which the set of data is to be distributed is determined, the total amount of data that should be transported across the network to properly distribute the data set can be determined. As will be discussed later, the total amount of data that should be transported across the network will often prove determinative of whether the set of data is distributed via a unicast mode or a multicast mode.

According to step 110 of flowchart 100, Asynchronous Layered Coding (ALC) protocol may be used according to the claimed invention to distribute the set of data. As specified in step 115, Forward Error Correction (FEC) schemes may also be used to distribute the set of data. Both of step 110 and 115 are particularly relevant when data in the set of data is distributed in packet form across an Ethernet network.

Step 120 of flowchart 100 is a decision step that specifies determining whether fewer than a predetermined number of nodes should receive the set of data and whether the set of data is smaller than a predetermined size. If it is determined both that fewer than the predetermined number of nodes should receive the set of data and that the set of data is smaller than the predetermined size, the next step of the method is step 122. Otherwise, the next step of the method is step 125.

Step 122 specifies unicasting the set of data to network nodes that should receive the set of data. As mentioned above, this step is carried out upon determining that fewer than a predetermined number of nodes should receive the set of data and that the set of data is smaller than a predetermined size. In other words, if step 122 is carried out, the set of data is small enough and sufficiently few network nodes need to receive the set of data. Therefore, individually unicasting to each of the nodes is the most efficient way to forward the set of data. Pursuant to this unicasting step 122, the flowchart jumps step 150, which will be discussed below according to the numerical sequence of the steps.

As mentioned previously, the set of data can take the form of a software application update and the network nodes can take the form of pieces of computerized nurse call equipment. Thus, when it is determined that relatively few pieces of nurse call equipment on the network need the software application update, and when it is determined that the software application update is of a relatively small size, a software application update can be distributed to each piece of nurse call equipment in a network via unicasting.

Regardless of whether the network includes computerized nurse call equipment or more general nodes, unicasting step 122 can include using File Transfer Protocol (FTP) to transfer the set of data. Such data transfer via FTP often optimizes the unicasting step 122.

Step 125 of flowchart 100 specifies multicasting the set of data to the nodes that should receive the set of data. Step 125 is typically performed upon determining either that more than the predetermined number of nodes should receive the set of data or that the set of data is larger than the predetermined size. Multicasting step 125 can include multicasting a software application update to pieces of computerized nurse call equipment or other computerized devices. Step 125 can also include using multicast FTP to transfer the set of data.

Since multicasting does not guarantee that each targeted node in a network has received the set of multicast data accurately and completely, step 130 specifies calculating the predetermined number of times that the set of data is to be re-multicast. This calculation is typically based on at least one of how many nodes in the network should receive the set of data, how large the set of data is, and the latency of the network.

Often, threshold values are specified. These values may be based on the average number of packets lost in a network and/or on average network congestion. These threshold values are used because both network congestion and packet loss is variable over time, generally as a function of network traffic variation over time.

According to one way of performing such a calculation, a large percentage of the devices (e.g., 50%) are assumed to not receive an accurate version of the set of data in a given multicast. Then, an estimate is made of the number of data streams (i.e., multicasts) that should be sent out to provide a reasonable probability that all of the intended devices receive the data accurately. Such an estimate can be made, for example, using Table 1, which takes into account the number of network nodes/devices that should receive the set of data and the size of the set of data.

TABLE 1
Minimum Number of Times to Stream the Set of Data

| Number of Network | Size of Set of | Number of |
|---|---|---|
| Nodes | Data | Streams |
| <100 | >1 MB | 5 |
| <100 | <1 MB | 7 |
| >100 | >1 MB | 10 |
| >100 | <1 MB | 15 |

As one possible alternative, the number of streams can be calculated based on the number of network nodes/devices and the size of the data set based on Table 2.

TABLE 2
Number of Streams Multiplier

| Number of Network | Size of Set | Multiply Number |
|---|---|---|
| Nodes | of Data | of Nodes by |
| <100 | >1 MB | 10% |
| <100 | <1 MB | 15% |
| >100 | >1 MB | 10% |
| >100 | <1 MB | 15% |

It should be noted that, when streaming the set of data, a form of Forward Error Correction (FEC) may be implemented. Also, it should be noted that the size of data packets that may be used to transport the set of data over the network may increase by as much as 200% due to FEC.

Based on the above, multicasting step 125 is often only used if the bandwidth savings over unicasting step 122 are more than a predetermined amount (e.g., 30%). However, no strict limitations are placed on when to perform multicasting step 125 rather than unicasting step 122, so long as some logical rationale exists for choosing one step over the other.

Returning to flowchart 100, step 135 specifies re-multicasting the set of data a predetermined number of times upon determining either that more than the predetermined number of nodes should receive the set of data or that the set of data is larger than the predetermined size. The number of times that the set of data is re-multicast according to step 135 is based on the above-mentioned calculations that make use of Tables 1 and/or 2.

Once re-multicasting step 135 has been performed, step 140 specifies determining whether any of the nodes that should have received the set of data failed to obtain an accurate version of the set of data. Step 140 is typically performed by obtaining feedback from the nodes that should have received the data. For example, if a network server is used to multicast the set of data, network nodes may be directed and/or designed to send messages to the server indicating whether or not they have received an accurate and completer version of the set of data.

If any nodes did fail to receive an accurate version of the set of data, step 145 specifies using unicasting to provide the accurate version of the set of data to nodes that should have received the set of data but failed to obtain the accurate version of the set of data. According to step 145, at least one unicast FTP session may be used to provide the accurate version of the set of data to each of the nodes that failed to obtain the accurate version of the set of data.

Step 150 specifies storing the set of data in a re-writable nonvolatile memory in at least one of the nodes that should receive the set of data. Step 150 typically follows either step 122 or step 145, depending on whether unicasting or multicasting was chosen to distribute the set of data. Once the set of data is stored in the re-writable nonvolatile memory, the data may be transferred to the Random Access Memory (RAM) of the node, the data may be decompressed or otherwise placed into a form that is usable by the node, and the software application of the particular node may be updated.

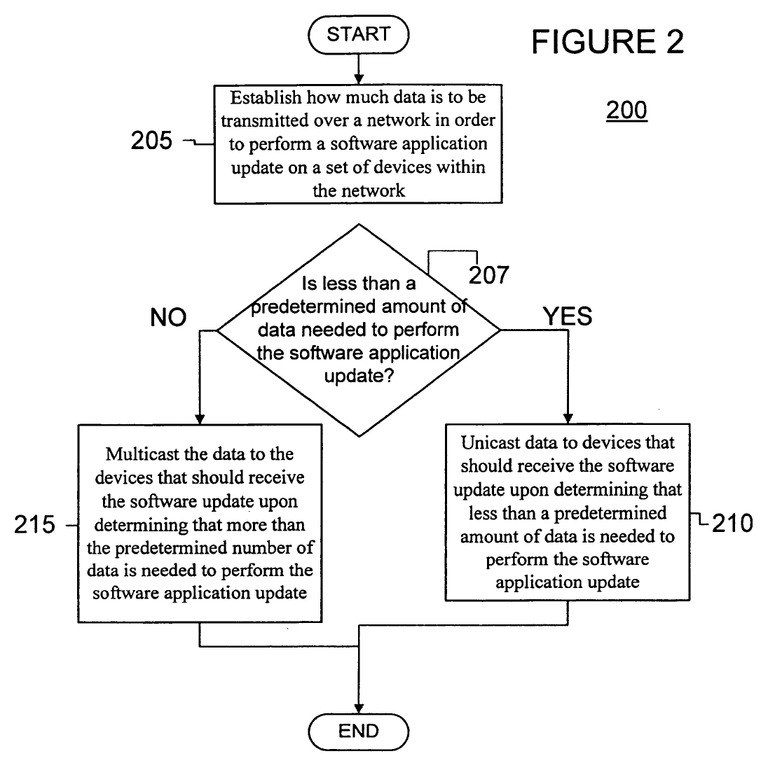

FIG. 2 illustrates flowchart 200, which includes the steps of a method of distributing a software application update to a plurality of devices in a network according to another embodiment of the claimed invention. Although no particular restrictions are placed on the types of devices that may be included in the network, according to certain embodiments of the claimed invention, one or more of the devices take the form of computerized nurse call equipment.

In flowchart 200, step 205 specifies establishing how much data is to be transmitted over a network in order to perform a software application update on a set of devices within the network. According to certain embodiments of the present invention, establishing step 205 includes determining how many devices in the network should receive the software application update and/or determining how large the software application update is.

Step 207 of flowchart 200 is a decision step that questions whether less than a predetermined amount of data is needed to perform the software application update. If it is determined that less than the predetermined amount of data is needed, the next step of the method is step 210. Otherwise, the next step of the method is step 215.

Step 210 specifies unicasting data to devices that should receive the software application update upon determining that fewer than a predetermined amount of data is needed to perform the software application update. Step 215, on the other hand, specifies multicasting the data to the devices that should receive the software application update upon determining that more than the predetermined number of data is needed to perform the software application update.

It should be apparent to one of skill in the art that which of unicast step 210 and multicast step 215 to perform depends on at least two factors: the size of the set of data that makes up the software application update and the number of nodes in the network that need to receive the update. In other words, whether to perform unicast step 210 or multicast step 215 may be decided based on the information included in Tables 1 and 2 and calculations related to those discussed in connection with flowchart 100.

The steps illustrated in flowcharts 100 and 200 may be implemented using any of a variety of networks. One representative network includes establishing means for establishing how many nodes in a network should receive a set of data. The establishing means can also be used for establishing how large the set of data is.

Operationally connected to the establishing means is a unicasting means. The unicasting means unicasts the set of data to nodes that should receive the set of data when it is determined that fewer than a predetermined number of nodes should receive the set of data and that the set of data is smaller than a predetermined size.

In addition, a multicasting means is included in the network such that the multicasting means is operationally connected to establishing means and/or the unicasting means. The multicasting means multicasts the set of data to the nodes that should receive the set of data when it is determined either that more than the predetermined number nodes should receive the set of data or that the set of data is larger than the predetermined size.

Determining means for determining whether any of the nodes that should receive the set of data failed to obtain an accurate version of the set of data are also included in the network. Further, using means for using unicasting to provide the accurate version of the set of data to nodes that should have received the set of data but failed to obtain the accurate version of the set of data are included. Each of the determining means and the using means may be operationally connected not only to each other but also to one or more of the establishing means, unicasting means, and multicasting means.

Typically, the multicasting means is configured to multicast a software application update as the set of data. Also, the unicasting means is typically configured to use FTP to transfer the set of data and the using means is typically configured to use at least one unicast FTP session to provide the accurate version of the set of data. However, these embodiments are not restrictive of the claimed invention.

Another component which may be included in the network is storing means for storing the set of data in a re-writable nonvolatile memory in at least one of the nodes that should receive the set of data. Once stored in the re-writable nonvolatile memory, the set of data may be transferred into RAM and/or decompressed to perform a software update.

Re-multicasting means may also be included in the network. The re-multicasting means re-multicasts the set of data a predetermined number of times upon determining either that more than the predetermined number of nodes should receive the set of data or that the set of data is larger than the predetermined size. The re-multicasting means is operably connected to calculating means for calculating the predetermined number of times that the set of data is re-multicast. The calculation may be based on at least one of how many nodes in the network should receive the set of data, how large the set of data is, and the latency of the network. Examples of such calculations have been included above.

Utilizing means for utilizing an ALC protocol to distribute the set of data may also be included, as may utilizing means for utilizing a FEC scheme to distribute the set of data. All of the components of the network may be operationally connected to one or more of the other components in the network.

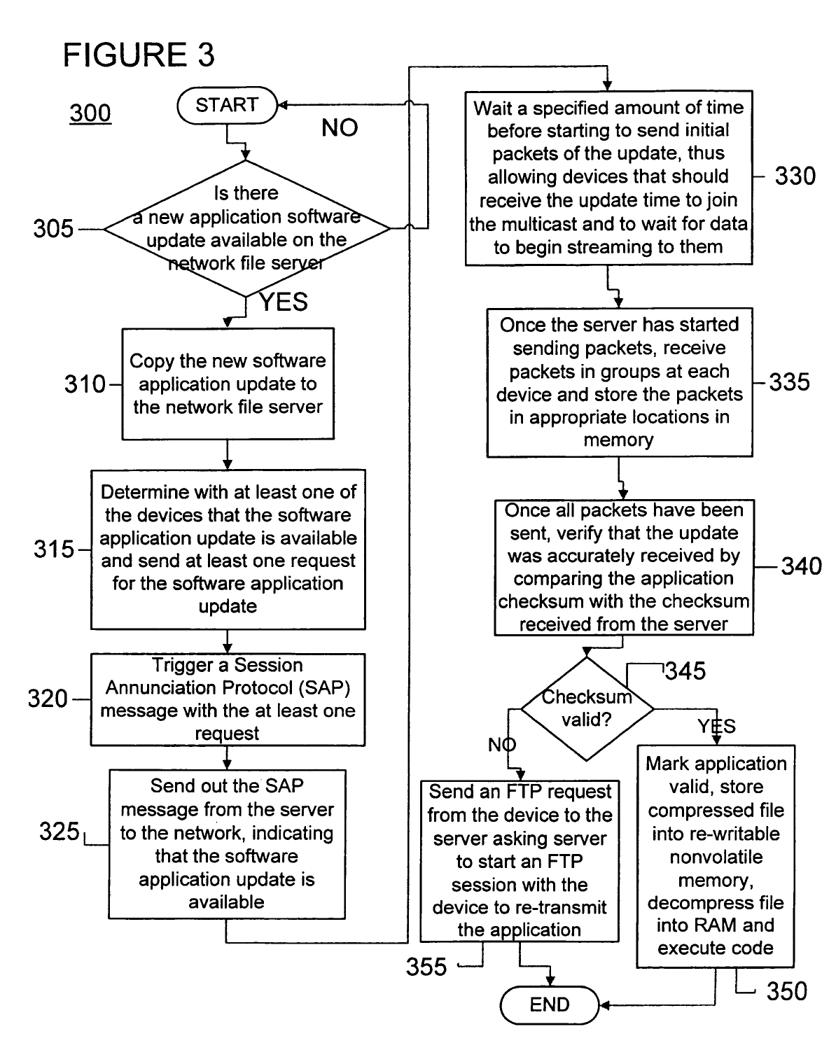

FIG. 3 illustrates a flowchart 300 that includes the steps of a method of distributing a set of data to a plurality of nodes in a network according to yet another embodiment of the claimed invention. Whereas flowcharts 100 and 200 were relatively more generic and could apply to a wide variety of networks, flowchart 300 is more specific to a particular subset of networks.

Step 305 of flowchart 300 is a decision step that questions whether there is a new software application update (i.e., a new set of data) available on a network file server. If no new software application update is available, the method starts over until one is detected. Otherwise, the method proceeds to step 310, which specifies copying the software application update to the network file server.

Once the software application update is on the network file server, step 315 specifies determining with at least one device on the network that the software application update is available. Step 315 also specifies sending at least one request for the software application update. Typically, this request comes from the at least one device.

Step 320 then specifies triggering a Session Annunciation Protocol (SAP) message with the at least one request. According to step 325, the SAP message is then sent out from the server to the network, indicating that the software application update is available.

As specified in step 330, a specified amount of time is waited out before initial data packets of the software application update are sent. This allows network devices that should receive the software application update time to join the multicast and to wait for data packets containing the update to begin streaming to them.

Step 335 next specifies receiving data packets in groups at each network device that should receive the software application update. Step 335 further specifies storing the packets in appropriate locations in the memory of the devices that receive the update once the server has started sending the data packets. Step 340 then specifies verifying that the software application update has been accurately received at a network device by comparing the application checksum with the checksum received from the server once all data packets have been sent.

In step 345, the validity of the checksum is checked. If the checksum is valid, step 350 specifies marking the application valid, storing the compressed filed into re-writable nonvolatile memory, decompressing the file into RAM and executing the code. If the checksum is invalid, step 355 specifies sending an FTP request from the network device to the server asking the server to start a unicast FTP session with the device to re-transmit the application.

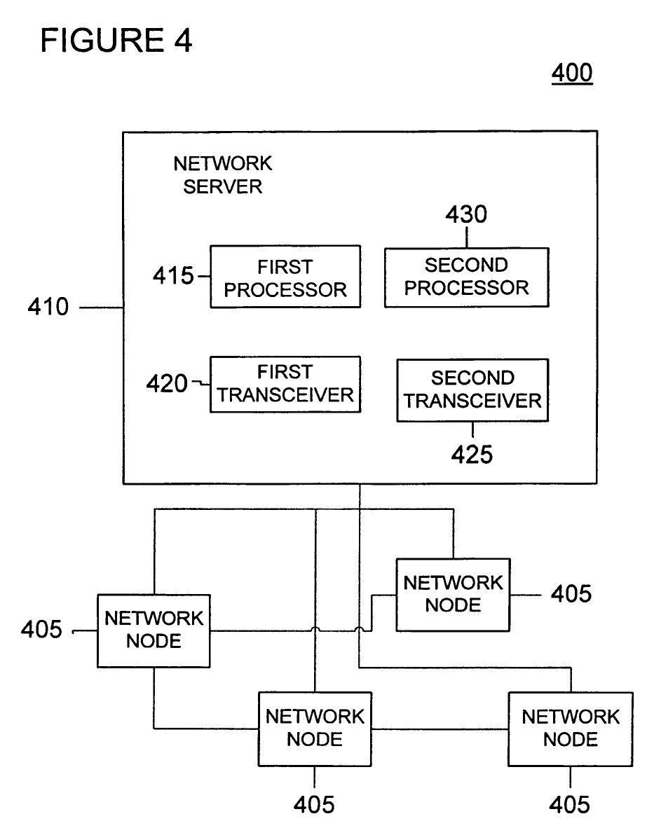

FIG. 4 illustrates a block diagram of a representative network 400 according to still another embodiment of the claimed invention. Network 400 may be used to implement one or more methods according to the claimed invention. As illustrated in FIG. 4, network 400 includes a plurality of network nodes 405 that are each operationally connected to at least one other network node 405 and to a network server 410.

Network server 410 includes a first processor 415, a first transceiver 420, a second transceiver 425 and a second processor 430. According to certain embodiments of the claimed invention, first processor 415 is configured to establish how many of the plurality of network nodes 405 should receive a set of data and how large the set of data is. As has been the case throughout this specification, the set of data may take the form of a software application update and the network nodes 405 may take the form of computerized nurse call equipment. No particular restrictions are made on the type of nurse call equipment that may function in or as a node 405, so long as the piece of nurse call equipment is capable of being networked either through an Ethernet or some other method.

First transceiver 420 is typically configured to unicast the set of data to nodes that should receive the set of data. Such unicasting is generally performed upon determining that fewer than a predetermined number of nodes should receive the set of data and upon further determining that the set of data is smaller than a predetermined size.

Second transceiver 425 is typically configured to multicast the set of data to the nodes that should receive the set of data. Such multicasting is generally performed upon determining either that more than the predetermined number of nodes should receive the set of data or that the set of data is larger than the predetermined size.

Second processor 430 is typically configured to determine whether the any of the nodes that should receive the set of data failed to obtain an accurate version of the set of data. According to certain embodiments of the claimed invention, second processor 430 uses feedback from network nodes to make the determination in question. If second processor 430 determines that there were one or more failures in distributing the set of data, the first transceiver 420 is typically configured to unicast accurate versions of the set of data to nodes 405 that failed to obtain an accurate version of the set of data pursuant to a multicast.

Although it should already be clear to those of skill in the art, the plurality of nodes in 405 and the network server 410 can form an Ethernet network. As such, data distributed between network nodes 405 and/or the network server 410 typically take the form of data packets. Also, at least one node 405 in the plurality network nodes 405 typically includes re-writable/memory. Once data is written into the re-writable nonvolatile memory, it may be transferred to the RAM of a network node 405 and a software application update may be implemented.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of distributing a set of data to a plurality of nodes in a network, the method comprising:
establishing how many nodes in a network should receive a set of data and how large the set of data is;
unicasting the set of data to nodes that should receive the set of data upon determining that fewer than a predetermined number of nodes should receive the set of data and that the set of data is smaller than a predetermined size; and
multicasting the set of data to the nodes that should receive the set of data upon determining either that more than the predetermined number of nodes should receive the set of data or that the set of data is larger than the predetermined size.

2. The method of claim 1, further comprising:
determining whether any of the nodes that should receive the set of data failed to obtain an accurate version of the set of data; and
using unicasting to provide the accurate version of the set of data to nodes that should have received the set of data but failed to obtain the accurate version of the set of data.

3. The method of claim 1, wherein the multicasting step comprises multicasting a software application update as the set of data.

4. The method of claim 1, further comprising:
storing the set of data in a re-writable nonvolatile memory in at least one of the nodes that should receive the set of data.

5. The method of claim 1, wherein the unicasting step comprises using File Transfer Protocol (FTP) to transfer the set of data.

6. The method of claim 1, further comprising:
re-multicasting the set of data a predetermined number of times upon determining either that more than the predetermined number of nodes should receive the set of data or that the set of data is larger than the predetermined size.

7. The method of claim 6, wherein the re-multicasting step further comprises:
calculating the predetermined number of times that the set of data is re-multicast based on at least one of how many nodes in the network should receive the set of data, how large the set of data is, and latency of the network.

8. The method of claim 2, wherein the using step comprises using at least one unicast File Transfer Protocol (FTP) session to provide the accurate version of the set of data to the nodes that failed to obtain the accurate version of the set of data.

9. The method of claim 1, further comprising:
utilizing an Asynchronous Layered Coding (ALC) protocol during at least one of the unicasting step and the multicasting step.

10. The method of claim 1, further comprising:
utilizing a Forward Error Correction (FEC) scheme during at least one of the unicasting step and the multicasting step.

11. A network, comprising:
establishing means for establishing how many nodes in a network should receive a set of data and how large the set of data is;
unicasting means for unicasting the set of data to nodes that should receive the set of data upon determining that fewer than a predetermined number of nodes should receive the set of data and that the set of data is smaller than a predetermined size; and
multicasting means for multicasting the set of data to the nodes that should receive the set of data upon determining either that more than the predetermined number of nodes should receive the set of data or that the set of data is larger than the predetermined size.

12. The network of claim 11, further comprising:
determining means for determining whether any of the nodes that should receive the set of data failed to obtain an accurate version of the set of data; and
using means for using unicasting to provide the accurate version of the set of data to nodes that should have received the set of data but failed to obtain the accurate version of the set of data.

13. The network of claim 11, wherein the multicasting means is configured to multicast a software application update as the set of data.

14. The network of claim 11, further comprising:
storing means for storing the set of data in a re-writable nonvolatile memory in at least one of the nodes that should receive the set of data.

15. The network of claim 11, wherein the unicasting means is configured to used File Transfer Protocol (FTP) to transfer the set of data.

16. The network of claim 11, further comprising:
re-multicasting means for re-multicasting the set of data a predetermined number of times upon determining either that more than the predetermined number of nodes should receive the set of data or that the set of data is larger than the predetermined size.

17. The network of claim 16, wherein the re-multicasting means further comprises:
calculating means for calculating the predetermined number of times that the set of data is re-multicast based on at least one of how many nodes in the network should receive the set of data, how large the set of data is, and latency of the network.

18. The network of claim 12, wherein the using means is configured to use at least one unicast File Transfer Protocol (FTP) session to provide the accurate version of the set of data.

19. The network of claim 11, further comprising:
utilizing means for utilizing an Asynchronous Layered Coding (ALC) protocol to distribute the set of data.

20. The network of claim 11, further comprising:
utilizing means for utilizing a Forward Error Correction (FEC) scheme to distribute the set of data.

21. A network, comprising:
a plurality of network nodes; and
a network server that is operably connected to the plurality of network nodes, wherein the network server includes;
a first processor configured to establish how many of the plurality of network nodes should receive a set of data and how large the set of data is,
a first transceiver configured to unicast the set of data to nodes that should receive the set of data upon determining that fewer than a predetermined number of nodes should receive the set of data and that the set of data is smaller than a predetermined size, and
a second transceiver configured to multicast the set of data to the nodes that should receive the set of data upon determining either that more than the predetermined number of nodes should receive the set of data or that the set of data is larger than the predetermined size.

22. The network of claim 21, wherein the network server further comprises:
a second processor configured to determine whether any of the nodes that should receive the set of data failed to obtain an accurate version of the set of data,
wherein the first transceiver is also configured to unicast the accurate version of the set of data to nodes that failed to obtain the accurate version of the set of data.

23. The network of claim 21, wherein the plurality of nodes and the network server form an Ethernet network.

24. The network of claim 21, wherein at least one node in the plurality of network nodes comprises re-writable nonvolatile memory.

25. The network of claim 21, wherein at least one node in the plurality of network nodes comprises a piece of nurse call equipment.

26. A method of distributing a software application update to a plurality of devices in a network, the method comprising:
establishing how much data is to be transmitted over a network in order to perform a software application update on a set of devices within the network;
unicasting data to devices that should receive the software application update upon determining that less than a predetermined amount of data is needed to perform the software application update; and
multicasting the data to the devices that should receive the software application update upon determining that more than the predetermined amount of data is needed to perform the software application update.

27. The method of claim 26, wherein the establishing step comprises at least one of determining how many devices in the network should receive the software application update and how large the software application update is.
